(19) United States
(12) Patent Application Publication
(10) Pub. No.: US 2026/0106475 A1
(43) Pub. Date: Apr. 16, 2026

(54) SYSTEM OF MULTIPLE ENTERPRISE DEVICES CHARGING SOLUTIONS FOR CORRECTIONAL FACILITIES

(71) Applicant: JACS Solutions, Linthicum Heights, MD (US)

(72) Inventors: Chang-Gang ZHANG, Escondido, CA (US); Yisai Wang, Linthicum Heights, MD (US)

(21) Appl. No.: 19/355,376

(22) Filed: Oct. 10, 2025

Related U.S. Application Data
(60) Provisional application No. 63/706,228, filed on Oct. 11, 2024.

(51) Int. Cl. H02J 7/00

(52) U.S. Cl. CPC H02J 7/731; H02J 7/80

(57) ABSTRACT

A comprehensive tablet charging system with solutions characterized by multiple embodiments covering critical use cases in correctional applications. Specifically, hardware hardened cabinet design, flexible design for portal cart and wall mount, guard rail slot design to support movable and replaceable charging trays, flexible configuration designs to support multiple device charging many tablets, heat management design for effective heat dissipation especially for wireless charging, power management design for power conversion, wireless charging compatibility, over current protection, and DC connecter based power interface.

### CROSS REFERENCE TO RELATED APPLICATIONS

The current application claims the benefit of U.S. Provisional Application No. 63/706,228, filed Oct. 11, 2024, the disclosure of which is incorporated herein by reference in its entirety.

### TECHNICAL FIELD

The present disclosure relates to the field of electronic device charging system, and more specifically charging solutions with multiple embodiments and structures of hardware and software components providing secure, anti-tamper, safe, sanitary, smart, wired and wireless charging solutions for simultaneous multiple mobile computing devices (e.g., computing tablets, smart phones, wearable computing devices, laptop computers and the like), particularly large numbers of devices, for example, up to 60 (or more) charging; and more specifically, for simultaneous multiple tablet computers charging in correctional facilities (it is understood that while the exemplary embodiments concern charging tablet computers, it is within the scope of the disclosure that other mobile devices may be contemplated for charging). This includes many innovative design features and implementations with hardware hardened charging cabinet, charging cabinets with efficient ventilation and heat dissipation, charging cabinets to accommodate UV lights, charging cabinets to support wireless charging, charging cabinets to support smart charging, charging cabinets with smart cameras to support AI enabled smart charging, multiple charging trays inside charging cabinets, charging trays with magnetic alignment and other features to support POGO pin interface based tablet computers, wireless charging trays, smart charging trays.

### BACKGROUND

Mobile and/or portable wireless devices such as smartphones, tablets, and wearables have become essential tools of people's daily life. However, due to battery life limitations, having those electronic devices properly charged has inevitably merged into people's daily activities. You find charging interfaces in the form of USB ports for example, everywhere, at home, in office, on a plane, in the shop, in most public places. There are plenty of charging stations deployed in public spaces to provide charging cables or ports to charge multiple devices. Those charging methods involve individual chargers and cables, leading to issues such as clutter, cable damage, self-service, no safety and protection, and so on, therefore, can hardly be suitable for enterprise devices charging applications, especially for correctional facilities, healthcare facilities, schools and the like. To overcome these issues, charging cabinets have been introduced to provide managed charging solutions for enterprise applications. Usually, charging cabinets are designed to have simultaneous multi-device charging capability. These cabinets offer the advantage of consolidating multiple charging interfaces into a single, organized unit, thus achieving the effect of mass charging and centralized management. However, existing charging cabinets often suffer from limitations such as insufficient charging capacity, lack of compatibility with different device types, and inadequate security measures, which can lead to theft and potential safety hazards like overheating or short circuits.

Businesses in various verticals, such as hospitals, manufacturing factories, schools, restaurants, etc., have deployed charging stations to charge enterprise devices. Typically, those charging stations are designed as cabinet like with built in charging cables of male type interface, or USB charging ports or interfaces. More commonly, enterprises increasingly rely on tablets for their operations. As a result, effective charging solutions to support charging multiple tablets have become an important consideration.

Moreover, in the enterprise application, tablets have been introduced in correctional facilities in recent years. This is a very unique industrial vertical with very special use cases, and thus tablets are designed with many special requirements: ruggedized tablet body for anti-tampering, locked or covered physical keys, avoid cable for safety, avoid consumer type of charging port or interface for safety, and so on. Thus, charging solutions need to accommodate those tablet hardware design changes. In addition, for safety and mass facility inmate population consideration, simultaneously charging multiple tablets needs to be supported.

Various charging stations have been developed to address the growing demand for efficient and organized charging of multiple electronic devices, particularly tablets. Many simple charging stations can be found during early days of charging station deployment. An example is shown in FIG. 1. It is a simple shelved furniture with divided sections, each section is equipped with a charging cable, charging cables are connected to power at back of the station. A cabinet is structured with multiple sections, pre-wired power lines with USB-C or Lightning at the back to provide cable interface for each section, a phone or tablet can be hooked up to a cable interface and placed in the corresponding section for charging. This type of solution is more for self-service and can also be seen in many public spaces. Obviously, this type of charging station may not satisfy the enterprise applications.

Later, many enterprise-oriented charging solutions were developed. Typical prior art examples are shown in FIG. 2, FIG. 3, FIG. 4, and FIG. 5.

FIG. 2 and FIG. 3 show charging cabinets with device dividers, pre-wired USB type ports, and slots for receiving tablets for charging. With these, users need to manually connect USB cables to charge multiple tablets simultaneously. FIG. 4 and FIG. 5 present more sophisticated prior art enterprise charging stations with steel cabinet type charging carts. These carts have security features with door and mechanical lockers, multiple shelves which can be sliding in and out, and pre-wired power lines with USB-C or Lightning cables. A phone or tablet can be placed on a shelf, and a user manually plugs in the charging cable interface to the device, slides the shelf in, and locks the cabinet during the period of charging. These types of solutions are designed to have security, multi device charging efficiency.

In some enterprise environments where enhanced security is required, besides the above-mentioned mechanical safety locker to prevent unauthorized access and theft of the devices being charged, a prior art charging cabinet is designed like stacked safety boxes with pre-wired charging cable interface as shown in FIG. 6. Each box is equipped with electronic safety lockers. This type of design mainly provides flexibility for individually controlled charging boxes.

As charging technology advances, wireless charging technologies have also been introduced in the market. Wireless charging is based on inductive charging technology. This process uses an electromagnetic field to transfer energy between two objects through electromagnetic induction. The energy is then sent through an inductive coupling to the device and then that energy is used to charge batteries or run the device. Consequently, some charging cabinets are designed to support wireless charging, thus manual cable plug in operation is reduced or eliminated.

However, despite its obvious advantage of eliminating manual cable plugging in and out operations, wireless charging technology faces challenges such as slower charging speeds, alignment issues, heating issues, charging efficiency, and higher cost with respect to wire charging.

It is no surprise that majority of charging stations are wire based in the markets, but wireless charging stations are used in enterprise market for certain special use cases. FIG. 7 provides an example prior art wireless charging cabinet. The prior art wireless charging cabinet of FIG. 7 includes a steel cabinet with multiple sections, each section has a safety box like design with a digital locker which is similar design as prior art charging cabinets discussed above. The primary difference is that there is a wireless charging pad with prewired charging coils inside a box, a device with wireless charging capability needs to be placed on top of charging pad and properly aligned/positioned for charging.

In recent years, smart charging systems have been developed. The smart charging station or smart charging cart is an application based on smart charging system. Typically, smart charging stations use RF tags and RF control modules to manage the charging of multiple devices. Thus, the charging station can automatically detect and convert the appropriate voltage for different types of devices and perform seamless and safe charging for multiple devices. Safety features such as protection against over-current and leakage are also integrated, ensuring device safety. Moreover, the built in control circuit also supports connectivity via wire or wireless, which makes charging process to be remotely controlled and monitored through a server, and allows for centralized and efficient management. Additional features such as individual device check-in and check-out, and device loaners are developed to quickly and remotely manage devices. A sample prior art smart charging station is shown in FIG. 8 and FIG. 9.

FIGS. 8 and 9 demonstrate primary functions that a smart charging station needs to support to qualified as a smart charging station. As it is seen, this sample smart charging station is structured to have multiple boxes to host multiple devices. It is prewired with USB-C or Lightning interface cable in each box, and it charges multiple devices simultaneously. The so-called smart components include a control unit equipped with a control board in an upper half of the station, a small screen, a keyboard, a speaker, and a tablet of large screen attached at the left side of the station. Obviously, the tablet serves as a brain for central processing. The smart functions implemented are mainly: smart digital locker for each box, and device access can be controlled (for instance, an authorization code can be assigned to an individual who then enters this code from key pad to unlock the box and access the assigned device); connectivity via wire or wireless through tablet, which makes charging process to be remotely controlled and monitored through a server; device management from backend server or locally through attached large screen display; centralized and efficient management; device safety control which automatically detects and converts the appropriate voltage for different types of devices, and performs seamless and safe charging for multiple devices; safety features such as protection against over-current and leakage are also integrated, ensuring device safety; and additional features such as individual device check-in and check-out, where a user can assign the right tech to the right people with automated oversight on who takes what device, and returning status.

Regardless of the prior art wire charging or wireless charging solutions, common components include: a steel cabinet with door; sliding shelf with dividers to hold multiple devices; multiple compartments to host devices; pre-wired USB or lightning cable interface to be manually plugged to corresponding devices. Another important point regarding sliding shelf is that it simply functions as a device holder with open space, and the device can be placed in a tray in any way. In the case of smart charging cabinet, the device is placed inside of compartment in various ways, and smartness is mainly focused on controlling box.

The prior arts have drawbacks and limitations including the following. Manual charging cable plug in and out, where this type of connection is subject to damage caused by vibrant, shock, drop, or external force. Additionally, managing multiple charging cords can be cumbersome, and frequently manual plugging and unplugging of devices can lead to wear and tear, further reducing the durability of the cables. Further, a USB interface, lightning interface, or DC in type of charging interface may be considered less safe and subject to tampering for certain industrial verticals such as correctional facility use cases.

Wireless charging carts supporting simultaneous charging larger number of tablets can cause heating issues, and charging box type of design approach doesn't take effective heat dissipation into consideration. The existing solutions also have limitations of expansion. To address the issue of heat dissipation, some patents have introduced the inclusion of ventilation spaces and exhaust fans within the charging cabinets. Usually, the design places the power supply area centrally within the cabinet, flanked by the product placement areas on both sides. This layout includes exhaust fans centrally positioned within the power supply area, coupled with ventilation openings in the product placement areas. The advantage of this design is that it evenly distributes heat across both sides of the cabinet. The internal air is drawn in through the ventilation openings, while hot air is expelled outside by the exhaust fans, maintaining a stable internal environment. Additionally, the power supply area is designed to be accessible from both the front and rear, making installation, adjustment, and overall cabinet maintenance more convenient and aesthetically pleasing. However, the exhaust fan may often shed dust and can be difficult to clean.

The prior smart charging stations show that the intelligence in design is mainly focused on the compartment or box but does not seem focused down to direct device level. In other words, the prior art smart charging carts appear to focus solutions to the control boxes.

With respect to smart charging, enterprises may deploy charging solutions across multiple organizations in various geo locations. Prior art smart charging stations or cabinets with local “smartness” are apparently not efficient to manage thousands of devices.

### SUMMARY

The methods, structure, and embodiments in the current disclosure provide innovative solutions to the above challenges by introducing a series of wall-mounted and/or floor-standing charging cabinets capable of charging multiple mobile computing devices (e.g., tablet computers, also referred to herein as “tablets”, as well as smart phones, laptop computers, wearable computers and the like) simultaneously. These cabinets are designed with advanced features such as magnetic alignment for secure positioning, enhanced safety mechanisms to prevent overheating and electrical faults, and compatibility with a wide range of tablet models, UV lights to sanitize tablets while charging, charging trays with wireless charging circuits and/or charging trays with device management capability. Certain embodiments can support up to 60 tablets for charging, which is not available in many similar products on the market. As to smart charging, embodiments of the current disclosure not only greatly expand the existing charging station locally based smart features, but also add smart cameras for edge AI, and further introduce cloud-based AI analytics. Embodiments may comprise computer intelligence both at edge level and cloud level, while all devices (trays, cabinets, cameras, and/or the mobiles devices being charged) may be networked and centrally managed by cloud.

As mentioned earlier, for safety reasons some tablet computers in correctional institutions use POGO pin type of interface instead of traditional barrel or USB type of charging port or interface (POGO type pin connectors are known in the art and typically comprise spring-loaded contact pins used to create reliable, temporary electrical connections between two devices or circuit boards. Pogo pins typically comprise three main components: a plunger, a barrel, and an internal spring-designed to maintain consistent contact under compression). Thus in some embodiments, the charging system utilizes POGO pin connection, offering a more reliable and durable method of connecting devices. The hidden charging cables of the exemplary devices avoid safety hazards and allow reduction in the placement space of the charging tablet, making it easier to manage the tablet's charging status and improving the overall work efficiency of the staff. The POGO pin design minimizes wear and tear, reduces the risk of connector damage, and provides a more streamlined charging process. Even in humid, corrosive environments, POGO pins typically do not rust or oxidize, maintaining long-term durability.

The current disclosure also introduces a unified app management system as an integral part of a cloud platform, allowing for centralized control and monitoring of connected devices. This app can manage software updates, monitor charging status, provide notifications for any issues, and facilitate unified app downloads. Additionally, the system includes Mobile Device Management (MDM) functionalities, offering comprehensive device management, including policy enforcement, device tracking, and security management.

Furthermore, embodiments of the charging cabinets feature advanced thermal management systems to dissipate heat effectively, preventing overheating and ensuring safe operation. The integration of UV lights for disinfection in some embodiments ensures that tablets are sanitized while charging, making the system suitable for environments where hygiene is a priority, such as hospitals, factories and schools.

This disclosure aims to improve the overall user experience by offering a reliable, efficient, and safe charging solution for educational institutions, businesses, hospitals and other organizations that rely heavily on tablet technology.

The disclosed methodology and systematic approach are utilized in designing charging carts for enterprise applications, more specifically for (but not limited to) correctional facility applications.

An aspect of the current disclosure provides a comprehensive tablet charging system with solutions characterized by multiple embodiments covering critical use cases in correctional applications. Specifically, hardware hardened cabinet design, flexible design for portal cart and wall mount, guard rail slot design to support movable and replaceable charging trays, flexible configuration designs to support multiple device charging from 10 tablets to 60 tablets (or more), heat management design for effective heat dissipation especially for wireless charging, power management design for power conversion, wireless charging compatibility, over current protection, DC connecter based power interface.

An aspect of the current disclosure provides a charging tray based POGO pin interface solution, where the tray structure is designed to fix and lock tablet to ensure POGO pin interface secure engagement, and includes a magnet design to enhance POGO pin interface secure engagement, and includes power management design for current control, protection, voltage conversion, and DC converter.

An aspect of the current disclosure provides a wireless charging solution, including a wireless, inductive charging pad design to integrate standard based wireless charging module, a tray design to integrate a wireless charging pad and keep the tray compatible with general tray, a tray heat management design for effective heat dissipation, and a power management design for current control, protection, and DC converter.

An aspect of the current disclosure provides a smart charging solution, including a device management functionality design to support device charging status monitoring, device user tracking, device software upgrade, device issue notifications, device applications push out or removal, security management functionality design to support device access control, device lockdown; and including a smart charging tray design to expand POGO pin to at least 5 pins or more in order to support data communications from charging tablet to tray and further to cabinet and cloud.

An aspect of the current disclosure provides a UV sanitary charging solution, including structure design for UV light position inside the charging cabinet to achieve optimum effectiveness, and including safety design with a smart switch to control UV light exposure within safety range.

An aspect of the current disclosure provides a charging tray for a tablet charging cabinet designed to hold multiple charging trays so that they can be slid into and out (at least partially) from the cabinet; where the charging tray includes (a) a base surface that tilts from the front of the tray to the back of the tray where a charging interface is located, (b) one or more magnets approximate the charging interface designed to pull a corresponding charging interface of a tablet (via, for example, ferromagnetic or magnetized materials in or on the tablet) towards the charging interface of the tray, (c) a cut-out portion of the based at the front end of the tray for providing handling access to the tablet from under the tray, (d) a cabinet interface provided on an outer surface of the tray and electrically communicating with the charging interface for engaging with a corresponding tray interface on the cabinet, which provides power to the charging interface via the cabinet interface when the tray is slid into the cabinet, and/or (c) a plurality of ventilation holes extending through the tray's base surface.

An aspect of the current disclosure provides an intelligent charging system design where AI based intelligence is split into central cloud AI capability and edge-based AI capability, and edge intelligence is further distributed into camera-based machine vision processing, and including camera-based bio-matrix processing, cabinet computer-based data processing, and charging tray-based data processing. The cloud platform design includes and/or supports integrated device management for tablets, trays, cameras, cabinets, subscriber management, security management of user credentials, authentications and data encryption, data storage (user data, camera video), cloud computing and AI analytics, video management, remote access management, applications management functionality. The smart centralized device management design includes linking tablets, trays, and users by association. A specific tablet configuration and associated applications can be personalized for effective management. The smart camera design includes correctional grade anti tampering casing, lens, AI computing, and integration into the charging cabinet.

An aspect of the current disclosure provides an apparatus for charging one or more mobile computing devices. The apparatus includes (A) a plurality of charging trays where each of the plurality of charging trays including: a seating area for receiving a respective mobile computing device thereon, the seating area having an open front end, a supporting surface and a closed rear end, an electrical charging interface provided in the closed rear end, the electrical charging interface adapted to mate with a corresponding electrical charging interface provided on the respective mobile computing device, one or more magnetic or ferromagnetic components provided in the closed rear end and facing the seating area and adapted to attract a corresponding ferromagnetic or magnetic component of the respective mobile computing device, a tray power connector provided in or on an outer surface of the charging tray, and circuitry providing charging power from the tray power connector to the electrical charging interface; and (B) a cabinet including a plurality of slots or shelves for seating the plurality of charging trays and a corresponding plurality of cabinet power connectors adapted to mate with respective charging trays when seated in the respective slot or shelf.

In a more detailed aspect, the electrical charging interface of each of the plurality of charging trays is a POGO connection. In a further detailed aspect, each of the plurality of charging trays include a male POGO interface. Alternatively, or in addition, the supporting surface of each of the plurality of charging trays is sloped downward from the open front end to the closed rear end. Alternatively, or in addition, each of the plurality of charging trays include opposing side surfaces that are spaced apart with a dimension adapted to snugly fit a respective mobile device therebetween. Alternatively, or in addition, the plurality of slots or shelves in the cabinet each comprise a pair of side rails upon which respective charging trays are adapted to slide into and out of the cabinet. Alternatively, or in addition, each of the plurality of charging trays include a bottom panel providing the seating area and a cut-out portion extending from the front of the bottom panel facilitating an ability for a person to grip a mobile computing device seated on the supporting surface through the cut-out portion. Alternatively, or in addition, each of the plurality of charging trays include a bottom panel providing the seating area, and a multitude of through-holes extending through the bottom panel facilitating heat dissipation from a mobile computing device seated in the seating area. Alternatively, or in addition, the apparatus further includes (C) a cabinet computer mounted thereto; and the apparatus further comprises a first level of smart computing functionality in each of the plurality of charging trays and a second level of smart computing in the cabinet computer or in an external computer networked with the cabinet computer. Alternatively, or in addition, the apparatus further includes (D) an IP camera provided on or with the charging cabinet and connected or networked with the cabinet computer or with the external computer, where the cabinet computer or the external computer may track users of the charging cabinet based upon information provided by the IP camera. Alternatively, or in addition, the cabinet computer performs two or more of the following operations: (i) monitoring charging status of the plurality of charging trays; (ii) managing access to the charging cabinet; (iii) associating charging trays with users; (iv) tracking mobile devices charged by the charging trays; or (v) providing software updates to mobile devices as they are being charged. Alternatively, the apparatus further includes (E) at least one UV light mounted within the cabinet and an associated switch configured to activate the UV light at least when a main door of the cabinet is closed.

An aspect of the current disclosure is to provide an apparatus for charging one or more mobile computing devices that includes: (A) a plurality of charging trays each of the plurality of charging trays including, a seating area for receiving a respective mobile computing device thereon, the seating area having an open front end, a supporting surface and a closed rear end, an inductive charging component provided on or adjacent to the supporting surface and adapted to inductively mate with a corresponding inductive charging element provided on the respective mobile computing device, a tray power connector provided in or on an outer surface of the charging tray, and circuitry providing charging power from the tray power connector to the inductive charging component; and (B) a cabinet including a plurality of slots or shelves for seating the plurality of charging trays and a corresponding plurality of cabinet power connectors adapted to mate with respective charging trays when seated in the respective slot or shelf; where each charging tray includes one or more of: (i) one or more magnetic or ferromagnetic components provided in the closed rear end and facing the seating area and adapted to attract a corresponding ferromagnetic or magnetic component of the respective mobile computing device, or (ii) the supporting surface of each of the plurality of charging trays being sloped downward from the open front end to the closed rear end.

An aspect of the current disclosure provides an apparatus that includes (A) a plurality of charging trays each of the plurality of charging trays including, a seating area for receiving a respective mobile computing device thereon, an electrical charging interface adapted to mate with a corresponding electrical charging interface provided on the respective mobile computing device, a tray power connector provided in or on an outer surface of the charging tray, and circuitry providing charging power from the tray power connector to the electrical charging interface, and for transmitting data between the tray power connector and the electrical charging interface; (B) a cabinet including a plurality of slots or shelves for seating the plurality of charging trays and a corresponding plurality of cabinet power connectors adapted to mate with respective charging trays when seated in the respective slot or shelf; (C) a cabinet computer mounted to or in the cabinet; (D) a first level of smart computing functionality in each of the plurality of charging trays; and (E) a second level of smart computing in the cabinet computer or in an external computer networked with the cabinet computer. In a more detailed aspect, the apparatus further includes (F) an IP camera provided on or with the charging cabinet and connected or networked with the cabinet computer or with the external computer, where the cabinet computer or the external computer may track users of the charging cabinet based upon information provided by the IP camera.

These and other aspects and advantages of the current disclosure will be apparent from the following description, the appended claims and the attached drawings.

### BRIEF DESCRIPTION OF THE DRAWINGS

FIG. 1 depicts an early stage, prior art, multiple device charging station commonly seen in public spaces, having a simple structure with multiple sections providing charging cable interface;

FIG. 2 depicts a prior art charging cabinet with device dividers to form multiple slots, prewired USB type port for each slot, where users place tablets in slots and manually plug in cables to charge devices;

FIG. 3 is another view of the prior art charging cabinet of FIG. 2;

FIG. 4 depicts a prior art charging station designed for enterprise applications, including steel cabinets with doors and mechanical lockers, sliding shelfs for holding devices, charging port cables, and requiring manual operation of plug in devices for charging;

FIG. 5 is another view of the prior art charging station of FIG. 4;

FIG. 6 depicts a prior art enterprise charging station with safety design and access control, including a charging cabinet with multiple stacked safety boxes and electronic door lockers to prevent unauthorized access or theft of the devices being charged, where each box is equipped with pre-wired cable interface;

FIG. 7 depicts a prior art charging station including steel cabinet with multiple sections, each section has a safety box like design with digital door lockers, a wireless charging pad with wireless charging module inside each box, and wireless charging pads pre-wired power sources inside the cabinet, which require users to place a device with wireless charging capability on top of charging pad properly for charging;

FIG. 8 depicts a prior art smart charging cabinet with centralized management, device check-in and check-out, devices loaner, remote device management, device access control, and attached computer for local control;

FIG. 9 is another view of the prior art smart charging station of FIG. 8;

FIG. 10 depicts an end view of an example computing tablet designed for correctional facility applications utilizing an exemplary POGO pin charging interface;

FIG. 11 depicts a front view of a first example embodiment of a charging cabinet design including guard rail type of slots on both sides of the cabinet inner walls, charging trays being slid in and out in slots, cabinet with enhanced safety, overcharge protection and overheating protection;

FIG. 12 depicts a close-up, interior view of the first exemplary charging cabinet design shown in FIG. 11 including an example charging tray seated in one of the charging slots of the cabinet;

FIG. 13A depicts a perspective view of an exemplary charging tray and installed computing tablet for charging;

FIG. 13B depicts an exploded view of FIG. 13A;

FIG. 14 depicts a cross-sectional, close-up view of an exemplary POGO pin interface between exemplary charging trays and computing tablets;

FIG. 15 depicts a close-up top view of an exemplary charging tray structurally designed with several arrays of holes in the tray base for effective heat dissipation;

FIG. 16 depicts a cross-sectional side view of an exemplary charging tray;

FIG. 17A depicts a circuitry side of an exemplary PCBA board providing an exemplary POGO pin interface for an exemplary charging tray;

FIG. 17B depicts a POGO pin interface side of the example PCBA board of FIG. 17A;

FIG. 18 depicts a perspective rear view of an example charging tray;

FIG. 19 depicts a perspective close-up view of an example charging tray engaging with a DC power connection within an exemplary charging cabinet;

FIG. 20 depicts a perspective cut-away view of the rear of an exemplary charging cabinet with a plurality of exemplary charging trays slotted therein;

FIG. 21 depicts a perspective cut-away top view of rear of an exemplary charging cabinet with a plurality of exemplary charging trays slotted therein;

FIG. 21 depicts an exploded view of an exemplary charging tray engaging with a DC power connection PCBA board of the exemplary charging cabinet;

FIG. 23 depicts an perspective interior view of an exemplary cabinet mechanical structure including spacing between trays and ventilation windows across the entire cabinet interior walls;

FIG. 24 depicts a perspective view of an embodiment of a smart charging cabinet design implementing two levels of intelligence—smart trays with embedded computing and an integrated computer;

FIG. 25 depicts a perspective view of an example embodiment of a smart charging cabinet design integrated with computer vision;

FIG. 26 is a schematic representation of a system diagram of the embodiment of FIG. 25;

FIG. 27 is a block diagram circuitry, wiring and networking layout of the exemplary smart charging cabinet design of FIG. 25;

FIG. 28 is a perspective interior front view of an example charging cabinet embodiment incorporating UV light sanitation; and

FIG. 29 is a front view of an interface for a smart switch for controlling aspects of the UV sanitizing functionality of the embodiment of FIG. 28.

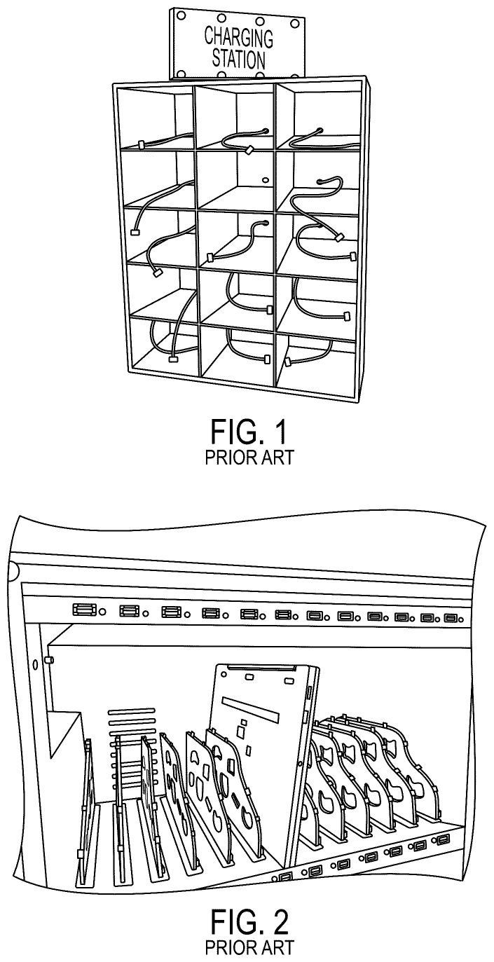

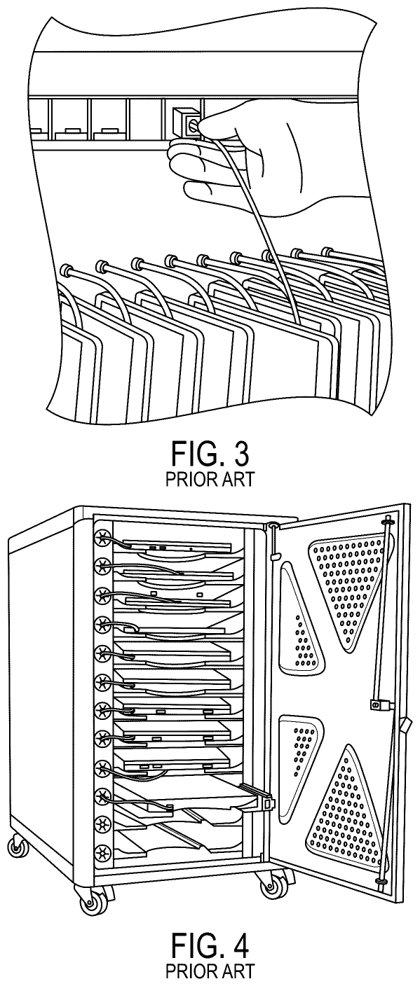

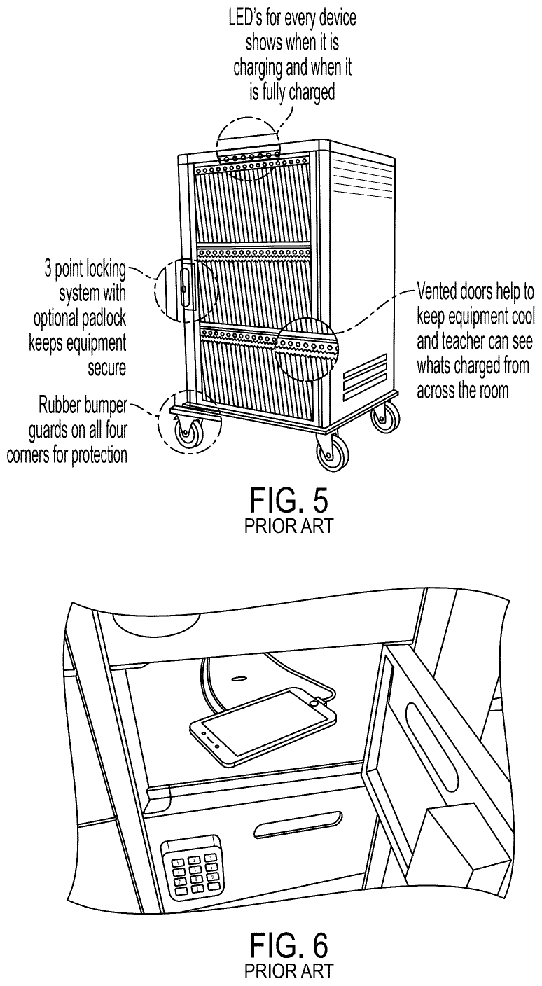

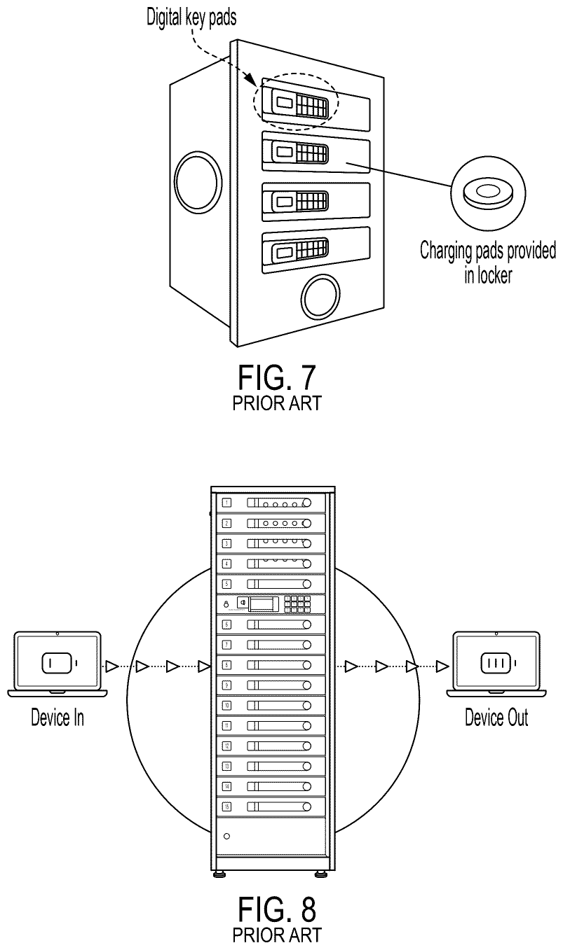

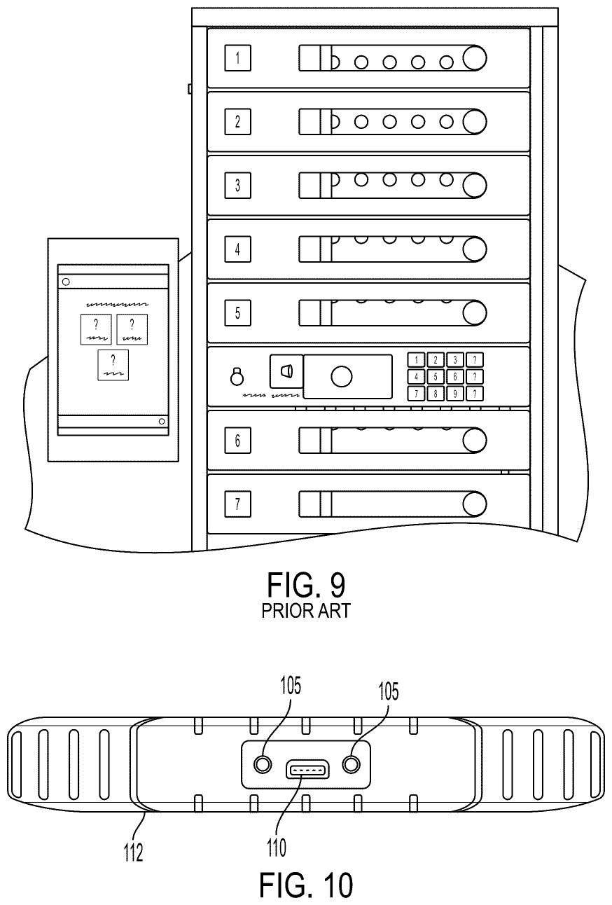

### DETAILED DESCRIPTION

While the exemplary embodiments pertain to charging cabinets and associated charging trays and related systems for charging tablet computers, it will be understood that the exemplary designs can be used for charging other mobile computing devices such as laptops, smartphones, wearable devices and the like. Likewise, when referring to a “tablet computer” or “tablet” in the following exemplary embodiments, such reference may also include any casing or covering provided on the mobile computing device that are commonly sold or provided separately from the computing devices themselves.

The present disclosure provides a system providing comprehensive charging solutions for charging multiple mobile devices (e.g., tablet computers) with several example embodiments covering various use cases faced in enterprise applications, while a central (and non-limiting) focus pertaining to uses within the correctional industry. The current disclosure presents multiple hardware structures designed to offer efficient, secure, intelligent and organized charging solutions for multiple tablets. The multiple embodiments of charging cabinets are provided to address issues related to cluttered cables, inefficient charging, safety concerns, and overall device management, thereby providing optimal solutions for various enterprise use cases, especially correctional use cases.

More specifically, when a charging cabinet is to be deployed in correctional facilities, it may advantageously be specially hardened and include rounded corners, for example, to protect it from tampering and to avoid it being weaponized. In a further embodiment, charging cables are not exposed, the cabinet includes efficient heat dissipation and ventilation, and the smart charging cabinet includes device level control capability.

Embodiments of the cabinet enclosure are designed to host multiple charging trays and at the same time to have flexibility to be configured in different capacities to accommodate different numbers of tablets, 10, 20, 30, 40, even 60 or more for instance, to be charged simultaneously. In some embodiments, charging trays are universal to be slot into various cabinet configurations. Further embodiments include CPU(s) and/or a control circuit(s) implemented in a charging tray and the charging cabinet can be upgraded as a “smart” cabinet/system with “smart” trays inserted.

The disclosure provides several non-limiting exemplary hardware structures or embodiments. A first example embodiment is shown in FIGS. 10-22. In the first example embodiment, a charging cabinet is designed to charge multiple mobile computing devices (e.g., tablet computers) simultaneously. The innovative design includes, in an exemplary embodiment, a POGO pin-based interface for the charging trays and additional mechanisms for facilitating easy or even automatic coupling of the POGO interface between the tablet and the tray. Such a design is advantageous for correctional facility use cases, for example, because cable-based charging interfaces involve manual operation which could be troublesome for inmate use; charging interface cables are subject to tampering and can potentially be weaponized; and third, tablets with USB or DC interfaces as charging interface may also subject to tampering and misuse. To address such concerns, many correctional tablets have adopted POGO pin type of charging interface as shown in FIG. 10.

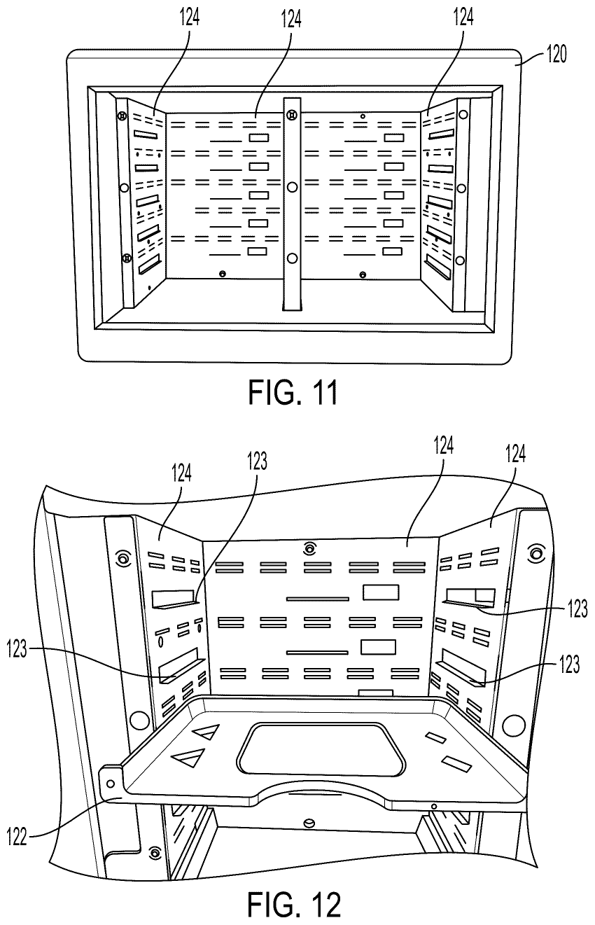

FIG. 10 depicts a POGO pin charging interface 110 for tablet 112 that replaces commonly used barrel DC charging interface or USB charging interface. Challenges arise for designing charging cabinets to support POGO pin interface, and to make pins in close contact for efficient charging with minimal manual intervention. In the current embodiment, as shown in FIGS. 11 and 12, the cabinet 120 is designed to host multiple trays 122 utilizing guard rail type of structure to allow trays to slide in and out supported by side rails 123 extending inward from both of the cabinet side walls 124. The charging cabinet may be designed with enhanced safety features, including overcharge protection and overheating protection.

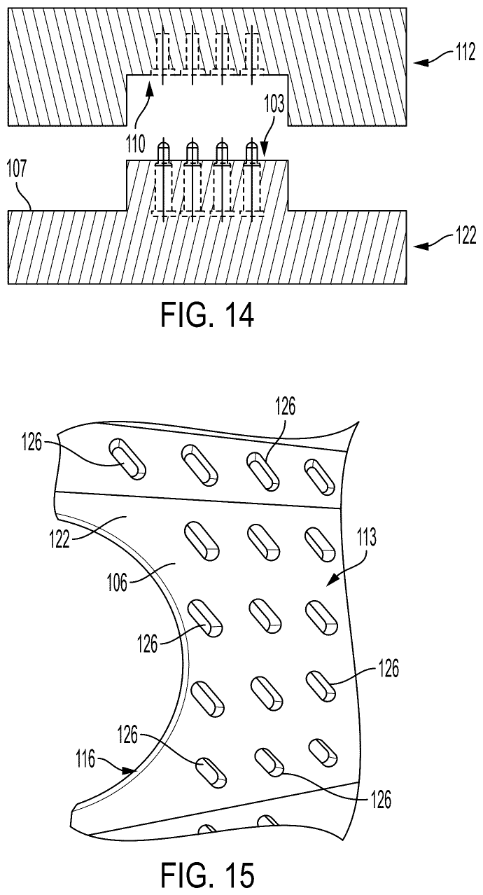

Some innovative ideas are associated with tray 122 design. Referring to FIG. 14, the embodiment utilizes POGO pin interfaces/connections 103/110, which are securely integrated into the tray 122 design to ensure a consistent and stable connection with the tablets 112 as will be described further below.

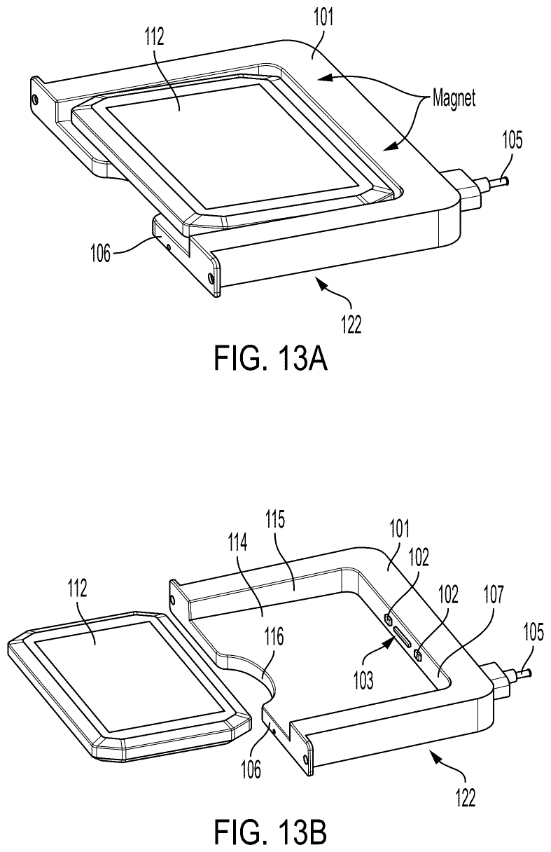

Referring to FIGS. 13A and 13B, an exemplary tray 122 is designed with embedded magnets 102 provided on a rear tablet-seating surface 107 of the tray and on each side of the POGO interface 103, which attract corresponding ferromagnetic components 105 (See FIG. 10) provided on the tablet 112 (or tablet cover) to align POGO pin contacts 103/110 tightly between tablet 112 and tray 122. Besides the magnet feature, the tray 122 is designed with tilted a tray supporting bottom panel 106 and snug-fitting side surfaces 115 dimensioned to hold tablet 112 tightly (or at least so that the tablet cannot slide laterally between the side surfaces 115) as it is illustrated in FIGS. 13A and 13B. These features are provided to securely position the tablet and ensure full pin to pin contact for good charging connections. The POGO pin design minimizes wear and tear, enhances overall charging efficiency and reliability. The POGO pins 103, combined with magnetic alignment, allow for easy docking of the devices 112 while minimizing wear and tear on the connectors. This design not only enhances the reliability of the charging process but also reduces the risk of loose connections or short circuits, providing a safer and more efficient charging environment. It will be understood that the magnets may alternatively be provided on the tablets 112 and attracted to ferromagnetic or magnetized components provided on the rear tablet-seating surface 107 of the tray 122.

FIG. 13A also illustrates an advantageous design feature in which the tablet supporting bottom (or base) panel 106 of tray 122 is formed with tablet supporting surface 114 that tilts at least slightly downwardly towards the POGO interface in the rear surface 107. As such, when a tablet 112 is placed in the tablet seating area (between rear surface 107 and side surfaces 115, where ethe rear surface provides an at least partially closed rear end of the seating area) the tablet may slide down the tilted surface 114 between the side surfaces 115 of the tray 122 towards the POGO interface with the help of gravity to move the tablet 112 into the desired engaged position, or to move the tablet 112 in close enough proximity to the rear surface 107 so that the magnetic attraction discussed above can take over or assist.

As shown in FIG. 13B, the tray includes a concave shaped cut out 116 (or otherwise indented portion) in the supporting bottom panel 106 and extending inward from an open front end portion of the tray 122. This cutout portion 116 allows a user to grip and remove a fully charged tablet 112 that is seated in the tray 122. The inclusion of such a cutout 116 ensures that the devices 112 can be easily accessed by a user's grip through the cutout. Since the tablet 112 is supposed to be tightly held inside the tray 122, extra gripping exposure on the tablet provided by the cutout 116 may be needed for a user to grab the tablet and take it out. The six-sided positioning tray 122 can hold a tablet 112 securely in place, preventing movement during charging and optimizing the use of space. This tray 122 design prevents tablets 112 from sliding out and maintains stable POGO pin contact lock, enhancing the overall charging reliability and preventing the tablet 112 from falling out of the tray 122 due to shaking and vibrations.

A magnified view of the charging tray's POGO pin interface design detail is shown in FIG. 14. As shown, in an embodiment, the male type of pin interface 103 on the tray 122 needs to be made in exact right height to fit precisely with female type of interface 110 on tablet 112.

During charging process, heat can be produced and accumulated. The charging tray design takes this factor into consideration, and the tray base panel 106 may include a plurality of through-holes 126 extending therethrough and uniformly distributed in certain pattern for effective heat dissipation as it is illustrated in FIG. 15.

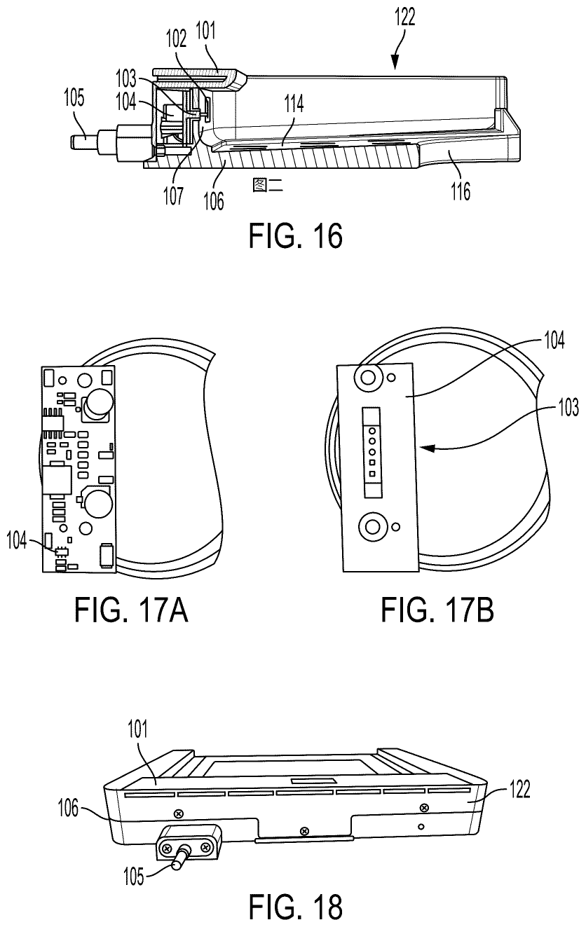

Additional tray 122 design details are depicted in the cross-sectional side view of FIG. 16. As shown in FIG. 16, the tray 122 may include an upper cover 101 that extends in a cantilever fashion from the rear of the tray to overhang the POGO pins 103 and magnets 102 and provide a rear enclosure (behind rear surface 107) for PCBA circuit board 104. PCBA (printed circuit board assembly) 104 is installed within the tray behind the rear surface 107 of the tray and between the base panel 106 and upper cover 101. A male DC connector 105 extends from the rear of the tray 122 and is adapted to interface with the female connector 128 provided in the cabinet as discussed below.

PCBA board 104 is shown in FIGS. 17A and 17B. A first side of the PCBA board 104 is shown in FIG. 17A and includes the designed circuitry for controlling charging current and distributions, provides surge protection, data management. The second side of the PCBA board 104 is shown in FIG. 17B and includes the POGO pins 103 to be connected to tablet 112. The specially designed PCBA board 104 also implements a function which converts a 9V power supply on board to 5V for charging the tablets via POGO pins 103, which supports protection to tablets 112 from potential damage caused by over voltage and reduces the loss of energy during the conversion process.

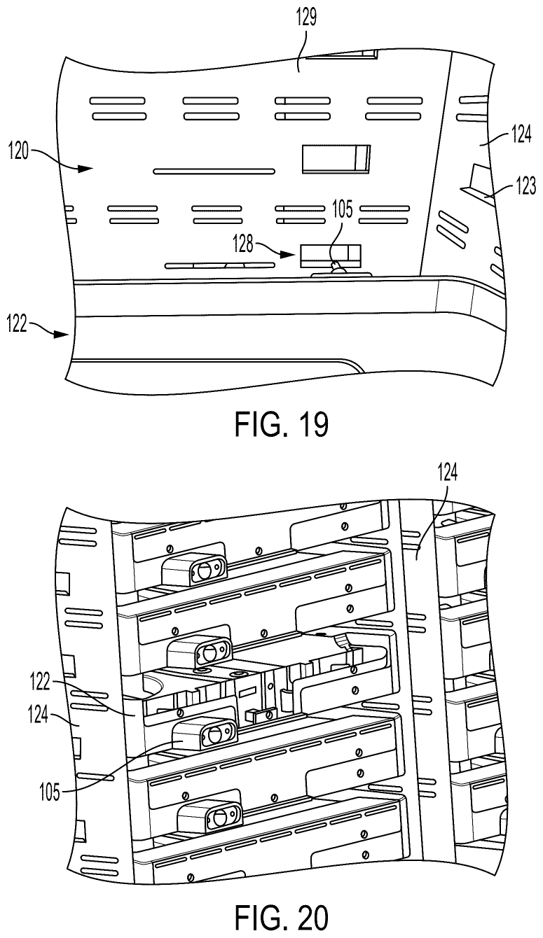

Referring to FIG. 18, the tray 122 is designed to have a male DC connector 105 electrically connected to the PCBA board 104 mounted within the tray. When the tray 122 is slid in toward the rear wall 129 of cabinet 120, the male DC connector 105 moves into a corresponding female DC connector 128 built in the rear wall 129 of the cabinet as shown in FIG. 19. FIG. 20 provides rear view of trays 122 slid in the cabinet 120 (with rear wall 129 of the cabinet 120 not shown).

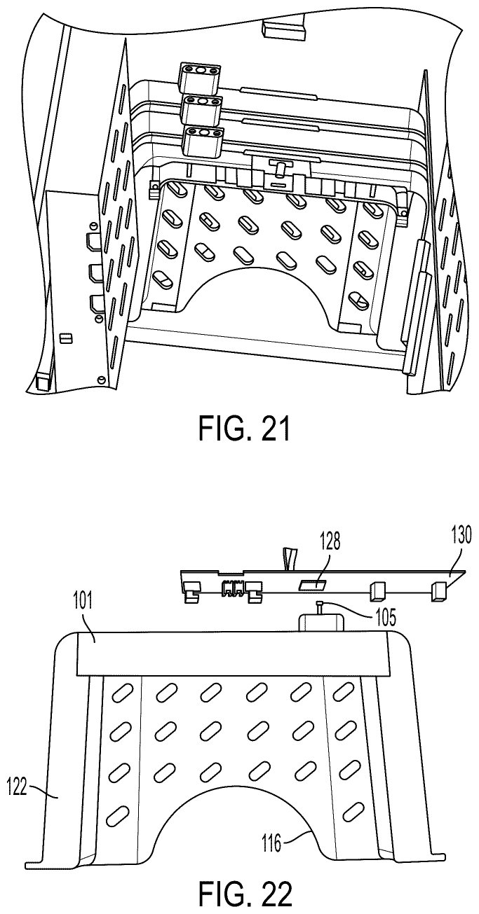

The cabinet 120 is designed with multiple slots defined by side walls 124, side rails 123, and rear wall 129 as shown in FIGS. 19, 11 and 12. When trays are slid in on rails 123, their DC connectors 105 are aligned precisely with the female ports 128 in the slots as shown in FIG. 20 and FIG. 21. Referring to FIG. 22, behind those slots are pre-wired female connectors 128 built on PCB boards 130. The cabinet has a structure to hold several arrays of PCB boards 130 in the positions in line with those slots in order to make connections with tray's DC connectors 105 perfectly when trays are slid in as it is seen in FIG. 22. Further, the cabinet is designed with a built in converter to convert regular 110V power source to 9V direct power. The PCB board 130 takes 9V power and distributes to one or multiple trays through female DC connector 128.

An example user operation of the tray is as follows: (1) pull a tray 122 out, for example, by holding the tray's curve cutout 116; (2) place the tablet 112 in the designated seating area on the surface 114 of base panel 106 between side walls 115 on the tray 122; and (3) push the tablet 112 and tray 122 inward into the cabinet 120 until the magnets engage the POGO connection 103/110 and the DC connector 105 engages the female DC connector 128, upon which the tablet 112 starts charging.

The design ensures that each tablet is securely held in place and charges efficiently, without the clutter of tangled cables, making it an ideal choice for optimizing space and improving operational efficiency in various corporate and industrial applications. The tray is designed to be replaceable for easy maintenance and future upgrade.

A second embodiment modifies a tray design to replace the POGO interface with an inductive, wireless charging assembly. POGO pin based charging interface presents safety and improvement with respect to traditional charging interfaces, especially for enterprise use cases like correctional facilities, as highlighted in the first example embodiment. But there still may be certain issues with a POGO pin based interface such as purposely tampering of pins by inmate users, and pin wearing, aging, misalignment. As a consequence, wireless charging based tablets may be desirable in certain correctional facilities or other environments. Following the similar design approach as the above first exemplary embodiment, the tray 122 in the second exemplary embodiment is modified to accommodate a tablet 112 equipped with wireless charging capability. The tray integrates a wireless charging module (such as an inductive charging module) centrally positioned (or otherwise positioned to correspond with the position of the corresponding wireless charging module in the tablet) in the tray base panel 106 and tablet mounting structures (such as side walls 115, back wall 107 and tilted surface 114 and/or magnets 102) in the tray ensure wireless charging components properly alignment between the tray and the tablet for consistent and efficient power delivery. Within the tray 122, the wireless charging component is electrically connected to male DC connector 105 via appropriate circuitry. As it is mentioned in the first exemplary embodiment, the cabinet is designed with a built in converter to convert regular 110V power source to 9V direct power. Such a design is to make the cabinet compatible to support wireless charging, since wireless charging standards currently specify up to 10 W charging requirement. With compatible design considerations, the cabinet can support mixed deployment of both wireless charging trays as discussed in the second exemplary embodiment and non-wireless charging trays as discussed in the first exemplary embodiment. This provides a flexibility for mixed tablets deployment scenarios.

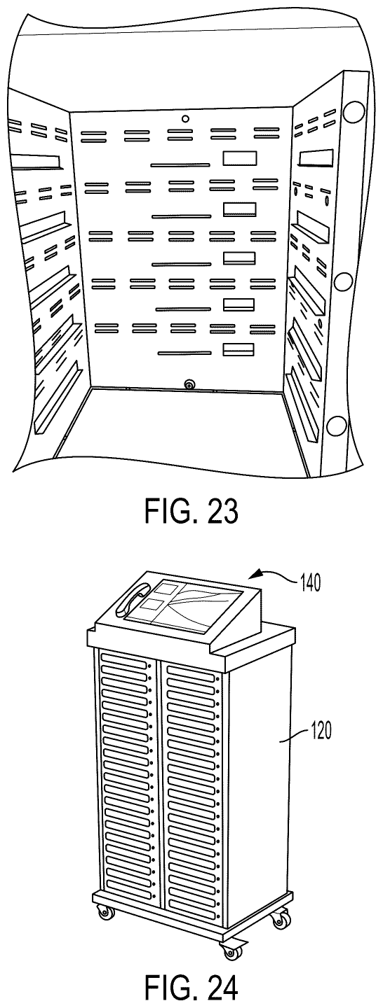

A challenging issue in design and development wireless charging cabinet is an advanced thermal management system to dissipate heat effectively, to prevent overheating and ensure safe operation. A large number of experiments and optimization cycles were conducted, covering cabinet mechanical structure in space between trays, ventilation windows cross entire cabinet as shown in FIG. 23, ventilation fan positions and air flows, ventilation holes on tray base, and so on.

A third exemplary embodiment further expands tray capability to support smart charging stations or charging cabinets. A charging cabinet in this third exemplary embodiment is designed to have device management functionality, security management functionality, device user tracking functionality, analytics functionality, AI functionality, application management functionality, etc., integrated with two levels (local and cloud) of control. This embodiment enables centralized control and monitoring of all charging devices. Software update operations, monitor charging status, software use and issue notifications, enforce policies, track devices, device check in and out, device lock down, and manage security. The smart charging cabinet designed in this third exemplary embodiment may implement two levels of intelligence, (1) smart trays with embedded computing and (2) an attached computer 140 as shown in FIG. 24.

In this third exemplary embodiment, “smart” functionality (involving objects/components each made intelligent with advanced computing—with or without AI and machine learning—and networked to form part of a system such as an internet of things) is split between computer and tray. Such a smart tray may include a digital locker, a charging display, a status display, blue tooth connectivity (BT) and/or near field communications (NFC).

In this third exemplary embodiment, the tablet charging interface is designed to support both charging and data transfer, so the POGO interface is a 7-pin interface rather than a 4-pin interface. The PCBA board further has a design enhancement to manage data communication in addition to power management. One design option is to wire data communication cables inside the cabinet for each tray and aggregate them to a data port of the attached computer 140. Another option is to add a Bluetooth (or the like) chip on the board to avoid wiring, and each tray communicates with the computer 140 through Bluetooth (or some similar wireless data connection).

A fourth exemplary embodiment expands cabinet-based intelligence and smartness design further into an intelligent system design where AI based intelligence is split into central cloud AI capability and edge-based AI capability through camera-based machine vision processing, camera-based bio-matrix processing, cabinet computer-based data processing, and charging tray-based data processing. With cloud-based AI computing and analytics, the designed charging system has a largely increased scope of use cases which can be supported. As rapid technology advancement in machine learning, machine vision, and AI computing and applications, the fourth exemplary embodiment charging solution is thus designed to integrate those innovations.

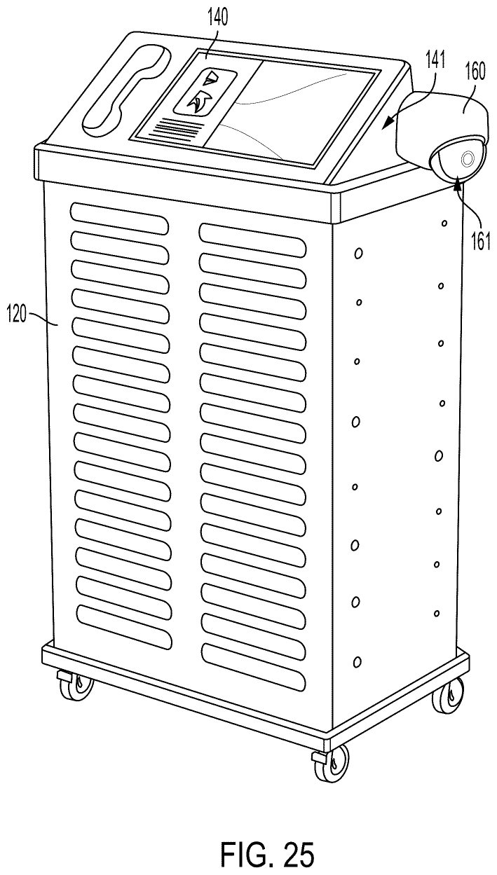

Referring to FIG. 25, in this fourth exemplary embodiment, an AI camera 160 may be added, for example, at the top edge of charging cabinet 120. The IP camera 160 may be added in the charging cabinet design to support smart features and AI capabilities by taking advantage of machine vision and cloud AI processing. Such features and capabilities are cloud based in an embodiment due to the associated computing resources, components and infrastructure that may be included to form a system supporting the multiple AI based intelligences contemplated.

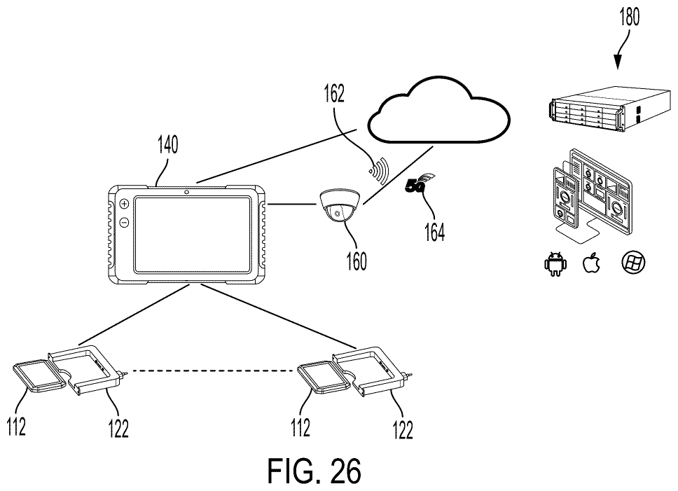

FIG. 26 provides an example system architecture diagram for the fourth exemplary embodiment. As shown in FIG. 26, multiple charging trays 122 are connected via data connections to a cabinet embedded computer 140; an IP camera 160 is connected to the same computer via RJ45 interface. The IP camera 160 is designed to have WiFi module 162 and 4G/5G cellular module 164 to support optional wireless networking connection in case no Ethernet access is available to the cabinet. Cloud server and storage 180 is connected to the computer 140 via Ethernet or camera through wireless, and a cloud sub-system is designed to support secure remote access anywhere, anytime from computer, phone, tablet running Windows, Android, or iOS.

Additional design considerations and embodiments. Referring to FIG. 25, the camera 160 casing including a semi-sphere transparent camera cover 161 may comprise correctional grade materials to stay in-line with correctional grade cabinets. The smart charging cabinet 120 may comprise a steel structured enclosure 141 to house and protect an attached computer 140, and the enclosure 141 may be an integral part of charging cabinet 120 steel structure. This is beneficial to resist tampering and weaponization risks in prison facilities. Referring to FIG. 26, the camera 160 may be designed to support three choices of data transmission mechanisms of networking, i.e., Ethernet module, WiFi module, and 4G/5G cellular module. Besides video processing, a camera circuit PCBA (not shown) embeds all components to support those 3 transmission mechanisms. Such flexibility is beneficial for prison facilities, since certain charging cabinet installation locations may not have Ethernet access, or WiFi access, while the cabinet computer 140 and camera 160 are beneficially connected via network connections to a cloud server 180 to support enhanced AI functions. In the specific example shown in FIGS. 25 and 26, charging trays 122 may use 7-pins PoGo interface to connect the tablet 112. As mentioned earlier, such an interface design supports both power delivery and data transmission between trays 122 and tablet 112. The smart functionality may be distributed into several different system components, i.e., smart tray handling; smart camera handling including image processing, security, identify verification and access control; attached computer handling including user interface, configuration management, access control of trays, firmware management of trays, data routing, and security policy management; backend server handling including subscriber data base, AI models, AI applications, and AI analytics.

Smart IP camera 160 design may have specific beneficial components and features: dual auto focus lenses and sensors, infrared sensor for night vision, Ethernet interface module, WiFi module, 4G/5G cellular module for networking, power management module, CPU/GPU for image processing, memory storage, correctional grade anti-tampering casing and camera cover 161, Ethernet module providing a RJ45 interface at camera base facing cabinet, RJ45 interface supporting power over Ethernet (POE), an Ethernet cable wired inside of cabinet to between camera 160 to attached computer 140 for providing power supply to the camera 160 and data communications between camera 160 and the computer 140. Smart sensor for facial recognition, fingerprint reading, bar code reading, SQ code reading, audio module for 2-way voice communications, and/or image sensor for machine vision.

Smart tray 122 design for the embodiment of FIGS. 25 and 26 may include functionality such as digital locker, LED based tablet charging status display, BT, NFC, data communications, power management, but may be enhanced with automatic open and close.

Attached computer 140 may be designed with functions such as: edge computing for AI processing, user interface (UI), configuration management of trays 122, configuration management of cameras 160, charging tablets software version control and management, charging tablets applications distribution, faulty and issue management, charging tablets access, and client services with respect to cloud server 180.

The cloud server 180 may be designed with functions such as: device management for tablets 112, trays 122, cameras 160, cabinets 120; subscriber management; security management of user credentials; authentications and data encryption; data storage (including user data, camera video and the like); cloud based computing and AI analytics; video management; remote access management; applications management functionality, etc.

The embodiment of FIGS. 25 and 26 may involve computing and intelligence in two levels—(1) local or edge and (2) cloud. This enables centralized control and monitoring of all charging cabinets and tablets. Tablets software update operations, tablets charging status monitoring, software use and issue notifications, security policies, access control, devices (trays 122, camera 160, cabinets 120, charging tablets 112) status tracking, charging tablets check in and check out, charging tablets lock down, trays lock down, and AI analytics can be managed at cloud level. Other computing light intelligence is implemented at edge level and is distributed among edge components such as camera 160, cabinet computer 140, and tray 122.

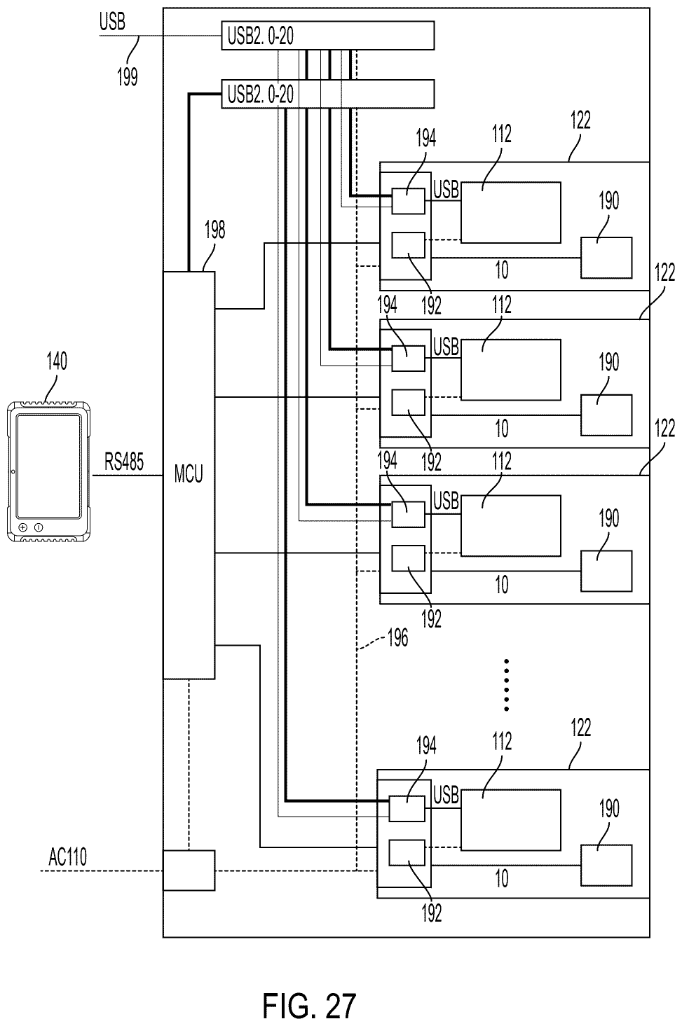

A smart cabinet electrical fabrication and connection diagram for the embodiments of FIGS. 25 and 26 is illustrated in FIG. 27. In reference to FIG. 27, each charging tray 122 may seat a charging tablet 112 and may include an LED (e.g., UV) light 190 a power control unit 192 and a data control unit 194. The tablets 112 may be connected to the respective trays 122 via POGO pin interface with line 196 representing power line, and other lines representing data lines (for USB connection in this implementation). All lines, power and data, concentrate to MCU 198 which is a master control unit, cabinet enclosed computer 140 is connected to MCU 198 via serial link RS485, cabinet has a power line AC110 for external power source, and data line 199 for external USB connection in this example. The external connection can also utilize Ethernet. For smart cabinet design, it is beneficial to have casket control units at each tray and at cabinet level for master control.

Example use cases for the embodiments of FIGS. 25-27 are now described. First, subscriber's data base is established in cloud server 180 with detailed user profiles including name, date of birth, ID number, phone number, address, email address, photo ID, finger print, device ID, and other attributes.

When a user approaches the charging cabinet 120, the camera 160 detects the user (or other objects associated with the user), tracks it, and then generates a notification.

When a user arrives in front of the cabinet 120, the computer 140 displays or elicits an audio greeting, and an AI agent offers voice prompt from which the user can choose either computer UI or voice to interact with cabinet 120.

When user indicates charging tablet access, the user identity verification and authentication process starts. Authentication can include user facial recognition with camera 160, fingerprint verification with fingerprint sensor (such as through the touch screen interface or through a specialized fingerprint sensor as known in the art), personal ID plus password verification via the computer 140 UI and so forth. The verification may involve a voice guided or UI guided process allowing the user to follow through easily. The user credentials are verified against user profile data stored in cloud database. The user can be granted access to a designated tablet only after successful verification, while the user's tablet and the tray containing the tablet may be linked in database. At this point, the tray 122 associated with the authenticated user may be automatically (or manually) slid out from the cabinet 120, and the user can remove the associated tablet 112 from the tray 122. Voice instruction may prompt the user to scan a tablet 112 bar code or QR code at camera 160 to complete check out. Thereafter, the empty tray 122 is to slid back into the cabinet automatically (or manually). In another scenario where a user wants to check in deposit a tablet 112 into cabinet 120 for charging a very similar process takes place. After user verification and authentication, a tray 112 is allocated to the user by system, then the allocated tray 122 slides out automatically (or manually) from the cabinet 120. Following voice instruction, the user scans its tablet 112 using camera 160 and places the tablet 112 into the allocated tray 122 to complete check in, upon which the tray 122 slides back into the cabinet 120 automatically (or manually). This event triggers system database update to link user, tray, and tablet together (although it is within the scope of the disclosure that these may be linked at any time).

This embodiment enables centralized smart management of tablets and their corresponding users, establishing a link between a user and a designated tablet. Therefore, tablet configuration and applications can be personalized for each user or a group of users. This is beneficial for correctional facility use cases where each inmate and his or her tablet needs to be diligently controlled and monitored, even for use and access to tablet applications. Further, tablets for inmates and for facility officers need to have different configurations and applications. In the evening (or other downtime) when all tablets are returned to cabinets for charging, devices management tasks can be performed, software upgrade, configuration changes, applications removal/deployment, tech issues diagnosis and patches deployment, security management, and so on.

Smart cameras 160 designed in this embodiment play key role in tablets and users management beyond simple charging. Supported by cloud server 180, users' interactions with cabinets may be observed by cameras 160 are processed, recorded, and stored in cloud server 180. Any event can be retrieved near real time using AI analytics. For smart cameras 160 exemplary design includes a minimum 2M dual lens with auto focus, correctional use cases AI models, CPU and NPU for image processing and edge AI models computing, and a software algorithm for video compression. Those are beneficial components to enable AI capability for smart cabinets.

Besides edge-based intelligence implemented in camera 160, cabinet computer 140, and tray 122, the most powerful intelligence may reside in cloud server platform 180. The core AI analytics tasks may be performed from central cloud server(s) 180.

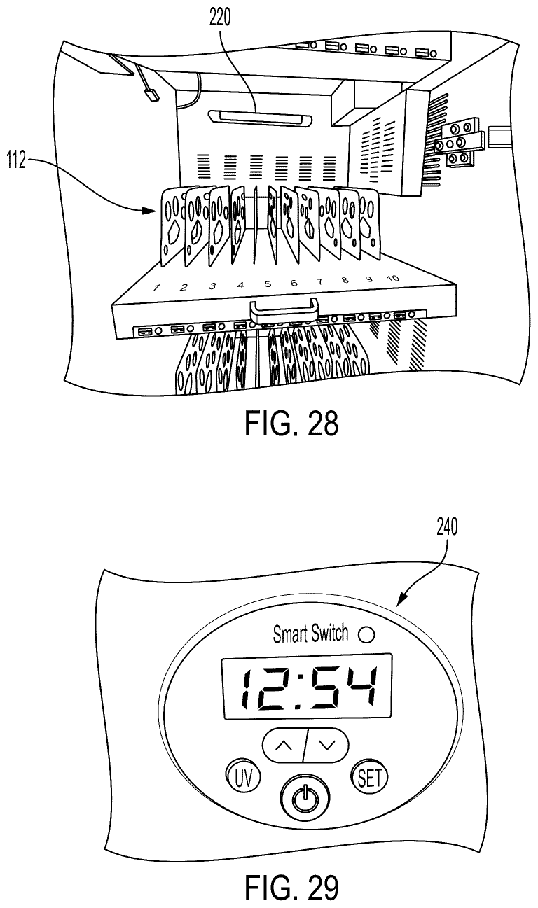

Another embodiment is described with respect to FIGS. 28 and 29. This embodiment expands the cabinet design to support use cases where tablets and other devices are deployed for medical applications in correctional facilities. In this embodiment, UV lights 220 are designed into a charging cabinet, and devices 112 are sanitized during the process of charging.

In a recent study conducted by the Pathogen and Microbiome Institute (PMI)'s COVID-19 Testing Service Center (CTSC) at Northern Arizona University, the Puritize® home sanitizing system (see, www.puritize.com, and patent disclosures U.S. Pat. Nos. 9,717,809 and 10,549,001, the patent disclosures of which are incorporated herein by reference), which uses UVC light technology, was found to effectively kill 99.9% of bacteria and viruses on personal items including SARS-COV2, as reported in a press release from Puritize® posted by the Arizona Bioindustry Association.

This embodiment design takes the following precautions for product safety: UVC lamps 220 may be carefully selected not to generate any 185 nm waves that can create ozone; UVC LED lamps are used in a way to reduce the risk of Mercury; safety labels are provided on the cabinet regarding UV exposure<—i.e. “do not open the door while UV light is on”; a software switch may be included to automatically turn the UV light off (or don't allow to turn UV light on) when charging station door is open; limits on any potential exposure based on safe exposure calculation of time and intensity according, for example, to the following equation 1.

$$U V Dose = U V Intensity ( μW / {cm}^{2} ) \times Exposure Time ( seconds )$$

UV light 220 position inside cabinet and smart switch 240 design for safety are demonstrated in FIGS. 28 and 29 in which smart control function is provided to turn on/off UV light and to set UV light exposure within safety range. The added UV feature ensures that tablets are sanitized while they are being charged, adding an extra layer of safety for correctional facilities, healthcare industry applications or applications beyond correctional facilities or healthcare.

In conclusion, the embodiments of the present disclosure provide a versatile and comprehensive charging management system for multiple tablets. The disclosure includes various configurations of wall-mounted and floor-standing charging cabinets and AI enabled smart charging cabinets, each designed to enhance charging efficiency. Features such as POGO pin connections, magnetic alignment, UV disinfection, heat dissipation, unified software management, camera and AI empowered intelligence, and cloud platform with integrated MDM and AI analytics may be provided to ensure that the system meets the diverse needs of educational institutions, businesses, and other industry environments, offering multiple effective solutions for enterprises secure devices charging applications.

Having described the inventions by way of example embodiments, it will be apparent that modifications may be made to such embodiments without departing from the scope of the appended claims. Further, the terms of such appended claims are intended to be construed according to their ordinary and customary meanings unless the detailed description expressly defines such terms otherwise, or unless such ordinary and customary meaning is materially inconsistent with how such term is used in the detailed description.

What is claimed:

1. An apparatus for charging one or more mobile computing devices, comprising:
a plurality of charging trays, each of the plurality of charging trays including,
a seating area for receiving a respective mobile computing device thereon, the seating area having an open front end, a supporting surface and at least a partially closed rear end,
an electrical charging interface provided in the at least partially closed rear end, the electrical charging interface adapted to mate with a corresponding electrical charging interface provided on the respective mobile computing device,
one or more magnetic or ferromagnetic components provided in the at least partially closed rear end and facing the seating area and adapted to attract a corresponding ferromagnetic or magnetic component of the respective mobile computing device,
a tray power connector provided in or on an outer surface of the charging tray, and
circuitry providing charging power from the tray power connector to the electrical charging interface; and
a cabinet including a plurality of slots or shelves for seating the plurality of charging trays and a corresponding plurality of cabinet power connectors adapted to mate with respective tray power connectors of respective charging trays when seated in a respective slot or shelf.

2. The apparatus of claim 1, wherein the electrical charging interface of each of the plurality of charging trays comprises a POGO connection.

3. The apparatus of claim 2, wherein each of the plurality of charging trays include a male POGO interface.

4. The apparatus of claim 1, wherein the supporting surface of each of the plurality of charging trays is sloped downward from the open front end to the at least partially closed rear end.

5. The apparatus of claim 4, wherein seating areas of each of the plurality of charging trays include opposing side surfaces that are spaced apart with a dimension adapted to snugly fit a respective mobile device therebetween.

6. The apparatus of claim 1, wherein the plurality of slots or shelves each comprise a pair of side rails upon which respective charging trays are adapted to slide into and out of the cabinet.

7. The apparatus of claim 1, wherein each of the plurality of charging trays include a bottom panel providing the seating area and a cut-out portion extending from the front of the bottom panel facilitating an ability for a person to grip a mobile computing device seated on the supporting surface through the cut-out portion.

8. The apparatus of claim 1, wherein each of the plurality of charging trays include a bottom panel providing the seating area, and a multitude of through-holes extending through the bottom panel facilitating heat dissipation from a mobile computing device seated in the seating area.

9. The apparatus of claim 1, wherein:
the charging cabinet includes a cabinet computer mounted thereto or therein;
the first and cabinet power connectors include one or more data lines facilitating communications between the charging trays and the cabinet computer; and
the charging interface of each of the plurality of trays includes one or more data lines facilitating communications between the cabinet computer.

10. The apparatus of claim 9, further comprising a first level of smart computing functionality in each of the plurality of charging trays and a second level of smart computing in the cabinet computer or in an external computer networked with the cabinet computer.

11. The apparatus of claim 1, wherein:
the cabinet includes a cabinet computer mounted thereto; and
the apparatus further comprises a first level of smart computing functionality in each of the plurality of charging trays and a second level of smart computing in the cabinet computer or in an external computer networked with the cabinet computer.

12. The apparatus of claim 11, further comprising an IP camera provided on or with the charging cabinet and connected or networked with the cabinet computer or with the external computer.

13. The apparatus of claim 12, wherein the cabinet computer or the external computer tracks users of the charging cabinet based upon information provided by the IP camera.

14. The apparatus of claim 11, wherein the cabinet computer performs two or more of the following operations:
monitoring charging status of the plurality of charging trays;
managing access to the charging cabinet;
associating charging trays with users;
tracking mobile devices charged by the charging trays; or
providing software updates to mobile devices as they are being charged.

15. The apparatus of claim 1, further comprising at least one UV light mounted within the cabinet and an associated switch configured to activate the UV light at least when a door of the cabinet is closed.

16. An apparatus for charging one or more mobile computing devices, comprising:
a plurality of charging trays each of the plurality of charging trays including,
a seating area for receiving a respective mobile computing device thereon, the seating area having an open front end, a supporting surface and a partially or fully closed rear end,
an inductive charging component provided on or adjacent to the supporting surface and adapted to inductively mate with a corresponding inductive charging element provided on the respective mobile computing device,
a tray power connector provided in or on an outer surface of the charging tray, and
circuitry providing charging power from the tray power connector to the inductive charging component; and
a cabinet including a plurality of slots or shelves for seating the plurality of charging trays and a corresponding plurality of cabinet power connectors adapted to mate with respective tray power connectors of respective charging trays when seated in the respective slot or shelf;
wherein each charging tray includes one or more of:
one or more magnetic or ferromagnetic components provided in the rear end and facing the seating area and adapted to attract a corresponding ferromagnetic or magnetic component of the respective mobile computing device, or
the supporting surface of each of the plurality of charging trays being sloped downward from the open front end to rear end.

17. A system for charging one or more mobile computing devices, comprising:
a plurality of charging trays each of the plurality of charging trays including,
a seating area for receiving a respective mobile computing device thereon,
an electrical charging interface adapted to mate with a corresponding electrical charging interface provided on the respective mobile computing device,
a tray power connector provided in or on an outer surface of the charging tray, and
circuitry providing charging power from the tray power connector to the electrical charging interface, and for transmitting data between the tray power connector and the electrical charging interface;
a cabinet including a plurality of slots or shelves for seating the plurality of charging trays and a corresponding plurality of cabinet power connectors adapted to mate with respective tray power connectors of respective charging trays when seated in the respective slot or shelf;
a cabinet computer mounted to or in the cabinet;
a first level of smart computing functionality in each of the plurality of charging trays; and
a second level of smart computing in the cabinet computer or in an external computer networked with the cabinet computer.

18. The system of claim 17, further comprising an IP camera provided on or with the charging cabinet and connected or networked with the cabinet computer or with the external computer.

19. The system of claim 18, wherein the cabinet computer or the external computer tracks users of the charging cabinet based upon information provided by the IP camera.

20. The system of claim 17, wherein the cabinet computer performs two or more of the following operations:
monitoring charging status of the plurality of charging trays;
managing access to the charging cabinet;
associating charging trays with users;
tracking users of the charging cabinet;
tracking mobile devices charged by the charging trays; or
providing software updates to mobile devices as they are being charged.

21. The system of claim 17, wherein the external computer comprises cloud-based computing.

22. The system of claim 21, wherein the cloud-based computing provides artificial intelligence based analytics to the system.

23. The system of claim 21, wherein the cloud-based computing provides artificial intelligence based image processing to the system.

24. An apparatus for charging one or more mobile computing devices, comprising:
a plurality of charging trays each of the plurality of charging trays including,
a seating area for receiving a respective mobile computing device thereon, the seating area having an open front end, a supporting surface and an at least partially closed rear end,
means for charging a mobile device deposited in the seating area,
mechanical means for registering the mobile device deposited in the seating area with the charging means,
a tray power connector provided in or on an outer surface of the charging tray, and
circuitry providing charging power from the tray power connector to the charging means; and
a cabinet including a plurality of slots or shelves for seating the plurality of charging trays and a corresponding plurality of cabinet power connectors adapted to mate with respective tray power connectors of respective charging trays when seated in the respective slot or shelf.
